(19) United States
(12) Patent Application Publication
(10) Pub. No.: US 2006/0189200 A1
(43) Pub. Date: Aug. 24, 2006

(54) Communication jack with wire pair spacing structure

(75) Inventor: Tsu-Yuan Ma, Taipei City (TW)

Correspondence Address: BIRCH STEWART KOLASCH & BIRCH, PO BOX 747, FALLS CHURCH, VA, 22040-0747, US

(73) Assignee: Hsing Chau Industrial Co., Ltd.

(21) Appl. No.: 11/064,403

(22) Filed: Feb. 24, 2005

(51) Int. Cl. H01R 4/24

(52) U.S. Cl. 439/404

(57) ABSTRACT

A communication jack with wire pair spacing structure includes an insulated body providing a receiving space and having two rows of parallelly arranged insulation displace contacts. A horizontal spacing member is located in and divides a space between the two rows of insulation displace contacts into two superposed spaces, namely, an upper and a lower space, and provided with two juxtaposed through holes to communicate the upper space with the lower space; and a vertical wall is downward extended from a bottom center of the horizontal spacing member to further divide the lower space into a left and a right channel. With the horizontal spacing member and the vertical wall, wire cores of a communication cable connected to the insulation displace contacts on the communication jack are effectively separated from one another to reduce cross talk between the wire cores.

### FIELD OF THE INVENTION

The present invention relates to a communication jack with wire pair spacing structure, and more particularly to a communication jack that has a wire pair spacing structure for wire pairs of a communication cable connected thereto to separate from one another and thereby reduces undesired cross talk, and also allows easy and controlled wire-pair management.

### BACKGROUND OF THE INVENTION

FIG. 1 shows a conventional communication jack 4, which includes an insulated body 41 having a receiving space 42, a plurality of spring contact terminals 43 arranged in the receiving space 42, two laterally parallel rows of insulation displace contacts (IDC's) 44 electrically connected to the spring contact terminals 43 for a plurality of wire cores 45 to connect thereto, and a cover (not shown) closed to a top of the insulation displace contacts 44. A communication plug (not shown) could be inserted into the receiving space 42 on the insulated body 41 of the communication jack 4 to achieve the purpose of signal transmission.

In the conventional communication jack 4, while the wire cores 45 are electrically isolated from one another by the sheaths thereof, they are actually not separated from each other. This condition results in cross talk and accordingly largely adversely affected signal transmission quality when the conventional communication jack 4 is used in current electronic apparatuses that require faster transmission speed. That is, the conventional communication jack 4 does not meet general users' requirements in terms of actual application thereof.

### SUMMARY OF THE INVENTION

A primary object of the present invention is to provide a communication jack with wire pair spacing structure, in which wire cores of a communication cable connected thereto are effectively separated from one another to reduce undesired cross talk and to enable easy and controlled wire-pair management.

To achieve the above and other objects, the communication jack with wire pair spacing structure according to the present invention includes an insulated body, a front end of which is formed of a receiving space; a plurality of spring contact terminals arranged in the receiving space; two rows of laterally symmetrically arranged insulation displace contacts electrically connected to the spring contact terminals for a plurality of wire cores of a communication cable to connect thereto; and a cover for closing to a top of the insulation displace contacts.

The wire pair spacing structure includes a horizontal spacing member, which is located in and divides a space between the two rows of insulation displace contacts into two superposed spaces, namely, an upper and a lower space, and is provided with two juxtaposed through holes to communicate the upper space with the lower space; and a vertical wall which is downward extended from a bottom center of the horizontal spacing member to divide the lower space into a left and a right channel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a conventional communication jack;

FIG. 2 is an exploded perspective view of a communication jack with wire pair spacing structure according to the present invention;

FIG. 3 is a partially assembled perspective view of the communication jack of FIG. 2;

FIG. 4 is a fully assembled perspective view of the communication jack of FIG. 2; and

FIG. 5 is a sectioned side view of the communication jack of FIG. 4.

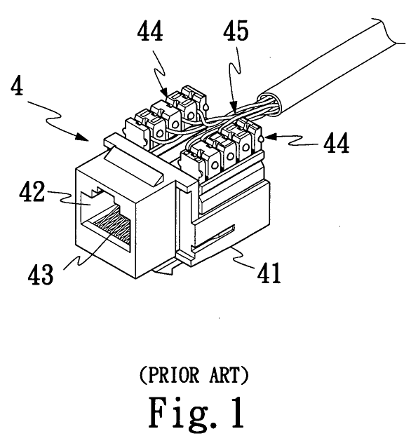

### DETAILED DESCRIPTION OF THE PREFERRED EMBODIMENTS

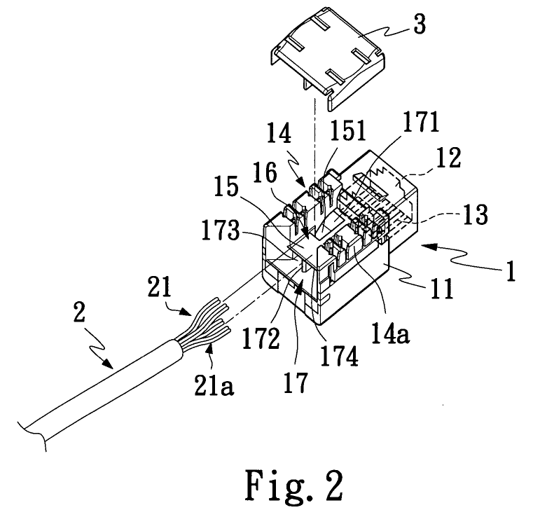

Please refer to FIG. 2 that is an exploded perspective view of a communication jack with wire pair spacing structure 1 according to the present invention for minimizing cross-talk interference. For the purpose of concision, the communication jack with wire pair spacing structure 1 is also referred to as “the communication jack 1” throughout the specification of the present invention.

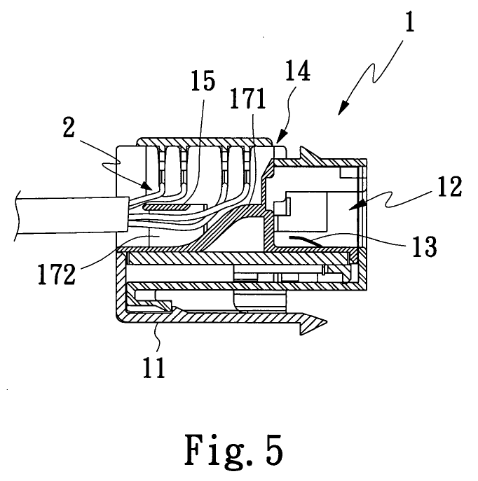

The communication jack 1 is of an RJ-45 jack (Registered Jack-45) including an insulated body 11, a front end of which is formed of a receiving space 12; a plurality of spring contact terminals 13 arranged in the receiving space 12; two rows of laterally parallelly arranged insulation displace contacts 14, 14a electrically connected to the spring contact terminals 13 for a plurality of wire cores 21, 21a of a communication cable 2 to connect thereto; a horizontal spacing member 15 located in and dividing a space between the two rows of insulation displace contacts 14, 14a into two superposed spaces, namely, an upper and a lower space 16, 17; and a cover 3 for closing to a top of the insulation displace contacts 14, 14a. The spacing member 15 is provided with two juxtaposed through holes 151 to communicate the upper space 16 with the lower space 17. A vertical wall 172 is downward extended from a bottom center of the horizontal spacing member 15 to further divide the lower space 17 into a left and a right channel 173, 174. Areas at a bottom of the lower space 17 corresponding to the two through holes 151 are separately formed into a slope 171 (see FIG. 5).

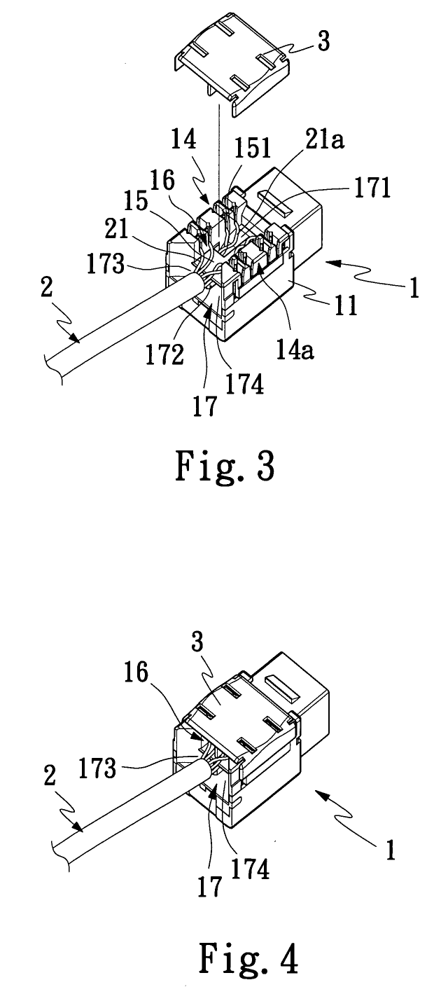

FIGS. 3 and 4 show the manner of assembling the communication jack 1 of the present invention, and FIG. 5 is a sectioned side view of the assembled communication jack 1. As can be seen from FIG. 2, the communication cable 2 has total eight wire cores, four of which are denoted with reference numeral 21 while the other four are denoted with reference numeral 21a. These eight wire cores 21 and 21a are grouped into four wire pairs, each of which includes two wire cores 21 or 21a. To assemble the communication jack 1, first separately extend the two wire pairs 21a through the left and the right channel 173, 174 of the lower space 17, so that they are guided by the slopes 171 to separately project from a corresponding one of the two through holes 151 on the spacing member 15 and be connected to a front section of the two rows of insulation displace contacts 14 and 14a, respectively. Then, lead the other two wire pairs 21 to the upper space 16 and connect them to a rear section of the two rows of insulation displace contacts 14 and 14a, respectively. Finally, close the cover 3 to the top of the insulation displace contacts 14, 14a. With the horizontal spacing member 15 and the vertical wall 172, the four wire pairs 21, 21a are sufficiently separated from one another to minimize the possible cross talk between the wire cores 21, 21a when the communication jack 1 is in use.

The present invention has been described with a preferred embodiment thereof and it is understood that many changes and modifications in the described embodiment can be carried out without departing from the scope and the spirit of the invention that is intended to be limited only by the appended claims.

1. (canceled)

2. (canceled)

3. A communication jack with a wire pair spacing structure, comprising:
an insulated body having a front end forming a receiving space;
a plurality of spring contact terminals arranged in said receiving space;
two parallel rows of laterally arranged insulation displace contacts which are electrically connected to said spring contact terminals, said insulation displace contacts receiving a plurality of wire cores of a communication cable for connection therewith;
a cover for closing a top of said insulation displace contacts;
a horizontal spacing member located between said two parallel rows and dividing a space between the rows into an upper and a lower space which are superposed;
said spacing member having two through holes to communicate said upper space with said lower space;
a vertical wall extending downwardly from a bottom of center of said horizontal spacing member to divide said lower space into a left channel and a right channel; and
a bottom of said left and right channels being shaped to slope upwardly towards said through holes, so that wire cores inserted into said left channel and said right channel extend upwardly through said through holes.
